(19) United States
(12) Patent Application Publication
(10) Pub. No.: US 2009/0082080 A1
(43) Pub. Date: Mar. 26, 2009

(54) GAME HAVING MULTIPLE HANDS

(76) Inventors: Nicholas Luke Bennett, Lane Cove (AU); Philippa Alice Graham, Lane Cove (AU); Christopher Stevens, Lane Cove (AU)

Correspondence Address: MCANDREWS HELD & MALLOY, LTD, 500 WEST MADISON STREET, SUITE 3400, CHICAGO, IL, 60661, US

(21) Appl. No.: 11/718,808

(22) PCT Filed: Jan. 3, 2007
(86) PCT No.: PCT/US07/00158

§ 371 Date: May 8, 2007

(30) Foreign Application Priority Data
Feb. 14, 2006 (AU) 2006900717

(51) Int. Cl. A63F 9/24; A63F 13/00

(52) U.S. Cl. 463/16; 463/42; 463/20

(57) ABSTRACT

A gaming system and method of gaming. A plurality of playing elements are selected, presented in symbol positions to form one or more outcomes that are evaluated for a winning combination. In one embodiment every one of a plurality of outcomes has at least one symbol position in common. In one embodiment the outcomes are formed at least in part by physical playing elements. In one embodiment the system and method involves a hold and draw style game utilising common playing elements across outcomes to avoid conflicts between potential outcomes.

### FIELD OF THE INVENTION

The present invention relates to gaming systems and methods of gaming. In particular, the present invention relates to a gaming machine and/or a table game and methods of gaming associated with each.

### BACKGROUND OF THE INVENTION

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming devices and systems have attempted to provide the sought after variety, while still developing games that comply with the relevant regulations in the jurisdiction of the gaming venue operator. Suppliers of gaming devices therefore are faced with restrictions on the types of games and gaming systems that are allowable, both in terms of the prevailing regulations and in terms of providing a return on investment to the gaming venue operators.

In addition, it is important that a player be able to understand the operation of a game quickly so that the player promptly feels that they are in control of game play and can therefore extract maximum entertainment from the game.

One type of existing gaming system incorporates spinning reels with pay lines. Australian patent number 684195 describes a spinning reel game with multiple pay lines. In spinning reel games of this type a large number of game outcomes is achieved by offering a large number of pay lines.

Another type of game is a “hold and draw” type spinning reel machine. In these games, a player is offered the opportunity on the next play of the game to hold reels and spin the remaining reels. For instance, if a spinning reel machine showed the symbols “A; Car; Car; Q; J” in a pay line, a sensible player would hold reels 2 and 3 and spin the remaining reels in the hope of getting 3 “Car” symbols.

In “hold and draw” type spinning reel games a problem arises because individual symbols can be common to multiple outcomes and/or because each reel is common to multiple outcomes. An example of conflicting possible winning hold strategies arising due to two reels being common to multiple outcomes in a hold and draw style spinning reel game having three rows and five columns of displayed reel symbols arises when the player is playing three pay lines, each pay line extending through the entirety of each row only. During this game it is possible in any given activation of the game that the player may be presented with a pattern such as:

| | | | | |
|---|---|---|---|---|
| K | K | Star | 10 | Q |
| A | Car | Car | Q | J |
| Star | 9 | 10 | J | K |

The player then does not know whether to hold the second and third reels (left to right) with the hope of getting 3 or more “Car” symbols on the centre line or to hold the first and second reels with the hope of getting 3 or more “K” symbols on the top line. The likelihood of conflicting hold strategies becomes more prevalent and more difficult to evaluate if the player is playing a larger number of pay lines that travel across the rows. For example, if the player was playing an additional two pay lines that extended diagonally across the pattern in a “V” and inverted “V” shape, the player may also want to hold the first and third reels with the hope of getting three or more “Star” symbols, and if the game allows winning combinations from right to left or anywhere on a payline, hold the fourth and fifth reels with the hope of getting three or more “Q” symbols.

Even if the player was able to hold individual symbols with the rest of the symbols being redrawn/re-spun, this does not entirely address the problem. Taking the five pay line example again when the game pays for left to right occurring combinations, the player does not know whether to hold the “Car” symbol in the second reel to try and get three or more “Car” symbols or redraw the symbol to try and get three or more “Star” symbols.

Another type of existing gaming system incorporates poker-style card games. Australian patent number 708901 discloses a card game that involves the simultaneous display of a plurality of hands, each hand comprising a predetermined number of cards randomly chosen without replacement from a deck of cards. Each hand has identical outcome probabilities that are independent of each other hand. In one embodiment cards may be held, at the player's discretion, during a draw to improve the dealt hand.

A hold and draw style card game is described in detail in Australian patent number 690499, which describes a game in which once a hand has been randomly chosen and the player has discarded the cards which the player does not wish to keep, the machine is arranged to allow multiple draws of new cards in combination with the same cards kept in the chosen hand to create a plurality of resultant hands for comparison with the predetermined winning hands.

Although hold and draw style card games of this type do not suffer from the problem of the possibility of conflicting hold strategies due to duplicating the held cards in every outcome, they suffer from a different problem of being able to effectively offer only a limited number of outcomes (hands) to a player. If a large number of distinct hands is offered and displayed on a display simultaneously, the hands can become difficult to view and evaluate. If the hands are instead displayed consecutively, then play of the game is considerably slowed.

Another type of existing game that is often provided at gaming venues is a table game. One type of table game is a poker-style card game as described in U.S. Pat. No. 5,531,448. Other types of table game include the well-known twenty-one or blackjack and roulette. Often customers of gaming venues have a strong preference for either gaming machines or table games and a gaming venue offering both types of games typically divide the venue into areas that have solely gaming machines and solely table games. Therefore, there is a problem that there currently exist two very different and separate groups of players with different objectives and expectations from gambling. These players do not tend to stray into playing other styles of games.

Although hold and draw style card games described previously herein have had some success in gaming machines, the requirement to duplicate the held cards across many game outcomes means that the game is not suited to implementation using physical cards. Therefore, hold and draw style table games, if provided, are limited to a small number of outcomes.

Games provided at gaming venues typically fall within a few classes of games, for example slot machine games, poker style card games and table games. There is an ongoing need to provide new types of games and systems to implement the games to provide potentially increased entertainment and variation to players.

It is an object of the present invention to provide a game that overcomes or alleviates problems in games and gaming systems at present, that provides interest or excitement to a player, that provides increased player control or choice in a game, and/or which at least provides the public with a useful choice.

Any reference in this specification to the prior art does not constitute an admission that such prior art was well known or forms part of the common general knowledge in any jurisdiction.

### SUMMARY OF THE INVENTION

In one aspect, there is provided a method of providing a game in which a player places a wager on a plurality of outcomes, a gaming apparatus forms the outcomes and if the outcomes represent one or more winning outcomes the gaming apparatus awards an award, the method comprising forming the outcomes by randomly selecting a plurality of playing elements, presenting each selected playing element in a single symbol position, and defining each outcome as a combination of the playing elements presented in a particular combination of symbol positions, wherein for every number of outcomes on which a wager is able to be staked, every one of the outcomes has at least one symbol position in common.

In another aspect, there is provided a gaming system comprising a display and a user interface in communication with a game controller comprising a memory containing definitions of a plurality of playing elements, wherein the game controller provides a game on the gaming system by randomly selecting some of the playing elements and causing the display to present each selected playing element in a single symbol position, and by causing the award of an award if at least one of a plurality of outcomes represented by the presented symbols is a winning outcome, wherein for every possible game play of the game every one of the outcomes has at least one symbol position in common.

In another aspect, there is provided a method of providing a hold and draw style game in which a plurality of playing elements are randomly selected and if the selection of playing elements represents a winning combination an award is awarded, the method comprising:

a) selecting and presenting one or more playing elements;
b) either holding or redrawing at least one of the playing elements dependent on a player input;
c) selecting and presenting with the playing elements resulting from step b) a plurality of further playing elements;
d) identifying a plurality of outcomes, each outcome defined by a combination of playing elements within the playing elements and further playing elements, at least two of the outcomes having one or more playing elements resulting from the decision in step b) in common; and
e) if the plurality of outcomes of playing elements represents a winning combination, awarding an award.

In another aspect, there is provided a gaming system for providing a hold and draw style game, the gaming system comprising one or more displays, a game controller and a memory containing definitions of a plurality of playing elements, wherein the game controller:
selects and causes the presentation on the one or more displays representations of a first selection of one or more said playing elements.
monitors a user interface for an identification from a player to either hold or redraw at least one of the presented playing elements and selects and presents replacement playing elements from the plurality of playing elements defined in memory for any playing elements identified by the player to be redrawn so as to define a second selection of playing elements,
selects a third selection of a plurality of playing elements from the plurality of playing elements defined in memory and displays on the one or more displays the second and third selection of playing elements,
identifies a plurality of outcomes, each outcome defined by a combination of playing elements within the playing elements from the second and third selection of playing elements, at least two said outcomes having one or more playing elements from the second selection of playing elements in common, and
causes the award of an award if one or more the plurality of outcomes represents a winning outcome.

In another aspect, there is provided a method of forming a plurality of outcomes of playing items, the method comprising randomly selecting one or more playing items from at least one set of playing items, either holding or redrawing one or more of the playing items dependent on a player input, and then forming and presenting simultaneously a plurality of outcomes, each outcome having one or more of the playing items resulting from the step of holding or redrawing in common, the step of presenting comprising displaying only a single representation of the common playing items.

In another aspect, there is provided a gaming system for providing a hold and draw style game, the gaming system comprising one or more displays, a user interface, a game controller and a memory containing definitions of a plurality of playing elements, wherein the game controller randomly selects one or more of the playing elements, either holds or redraws one or more of the playing elements dependent on a player decision entered using the user interface, forms a plurality of outcomes, each outcome having one or more of the playing items resulting from the step of holding or redrawing in common, and simultaneously displays each outcome on the display so that the one or more common playing items are only displayed once.

In another aspect, there is provided a gaming system comprising a display, an operator interface, and a controller in communication with the display and operator interface and operable to both control at least an aspect of game play of a game and cause representations of the game play to be displayed on the display, the controller selecting a plurality of playing elements from a set of playing elements and displaying the playing elements on the display, receiving at the operator interface an indication of a partial or full outcome, and then defining a plurality of full outcomes using both the selected playing elements and the indication of the partial or full outcome, and evaluating whether one or more of said plurality of full outcomes is a winning outcome.

In another aspect, there is provided a method of gaming comprising:

a) allocating to at least one player one or more physical game pieces to form at least one first partial or complete outcome;
b) using a computational game controller and one or more displays to select and display a plurality of playing elements;
c) for each said player forming a plurality of distinct complete outcomes using the physical game pieces and the plurality of playing elements; and
d) determining whether the plurality of complete outcomes define one or more winning outcomes and if so awarding an award.

In another aspect, there is provided a method of gaming comprising forming an outcome of at least two playing elements and awarding an award if the playing elements represent a winning combination, wherein at least one of the playing elements comprises a physical game piece and at least one of the playing elements comprises a playing element that has been randomly selected using a computational system and displayed on one of an electronic and electromechanical display.

In another aspect, there is provided a linked gaming system in which a plurality of gaming consoles each display one or more first playing elements representing at least part of an outcome in a game on a first display and the gaming system displays on a second display second playing elements representing part of a plurality of outcomes, wherein a plurality of outcomes for a game on the linked gaming system are defined by combining both the first and the second playing elements.

In another aspect, there is provided a gaming system comprising a plurality of linked consoles each having a display and a game controller, wherein the game controller controls play of a game having a common aspect across the plurality of linked consoles and during play of the game causes the plurality of gaming consoles to each display on their respective display one or more first playing elements representing at least part of a plurality of outcomes in a game, the first playing elements being common across the gaming consoles, and display second playing elements representing at least another part of the plurality of outcomes, the second playing elements being randomly selected for each gaming console, wherein outcomes for a game on the linked gaming system are defined by both the first and second playing elements.

In another aspect, there is provided a method of providing a game comprising randomly selecting a first set of playing elements from a set of playing elements, providing the option to replace one or more of the playing elements in the first set with one or more other playing elements to thereby form a second set of playing elements, selecting a plurality of further playing elements and forming a plurality of outcomes, each outcome having the second set of playing elements in common and including a different one or combination of said further playing elements.

In another aspect, there is provided a method of forming a plurality of outcomes of playing items, the method comprising randomly selecting and presenting one or more groups of reselectable playing elements, either holding or reselecting the reselectable playing elements dependent on a player input, and forming a plurality of outcomes from the reselectable playing elements and a plurality of further playing elements that form at least part of at least one set of playing elements, each set comprising either no reselectable playing elements or one of the reselectable playing elements from each group, wherein each outcome comprises only one playing element from each of the sets of playing elements and the number of outcomes is equal to the product of the number of playing elements in each set of playing elements multiplied by the number of groups of reselectable playing items and wherein every outcome comprises at least one common reselectable symbol.

In another aspect, there is provided a gaming machine comprising a game controller in communication with one or more displays and a player input device, the game controller randomly selecting one or more groups of playing elements, either holding or reselecting those playing elements dependent on input from the player input device, and presents on the one or more displays a plurality of outcomes from the reselectable playing elements and a plurality of further playing elements that form at least part of at least one set of playing elements, each set comprising either no reselectable playing elements or one of the reselectable playing elements from each group, wherein each outcome comprises only one playing element from each of the sets of playing elements and the number of outcomes is equal to the product of the number of playing elements in each set of playing elements multiplied by the number of groups of reselectable playing items and wherein every outcome comprises at least one common reselectable symbol.

In another aspect, there is provided a method of gaming comprising forming a plurality of outcomes, evaluating the plurality of outcomes for the occurrence of one or more winning outcomes and dependent on the evaluation awarding an award, the step of forming a plurality of outcomes comprising randomly selecting a plurality of playing elements and either holding or redrawing at least one said playing element, wherein the outcomes are defined to avoid the possibility of conflicting possible winning strategies when making the decision to either hold or redraw at least one said playing element and wherein the plurality of playing elements are presented without the duplicate display of playing elements.

In another aspect, there is provided a gaming system comprising a display and a user interface in communication with a game controller for providing a hold and draw style game in which a plurality of playing elements are selected and if a particular combination of playing elements occurs the gaming system awards an award, the gaming system further comprising memory containing definitions of a plurality of playing elements, wherein the game controller:

selects and presents a plurality of playing elements in a selection process during which one or more playing elements are selected and presented to a player; and
either holds or redraws at least one of the playing elements dependent on operation of the user interface by the player;
wherein the outcomes are defined to avoid the possibility of conflicting possible winning strategies when completing the step of either holding or redrawing at least one of the playing elements, and are presented without the duplicate display of playing elements, either simultaneously or consecutively.

In another aspect, there is provided a method of gaming comprising forming a plurality of outcomes and awarding an award if the outcomes represent one or more winning outcomes, the step of forming a plurality of outcomes comprising a process involving a random selection of a plurality of playing elements and during which:
a decision is made to either hold or redraw at least one said playing element, and
defining each of the plurality of outcomes as the playing elements in a pattern within the plurality of playing elements as displayed, wherein at least two patterns have at least one playing element in common,
   wherein the outcomes are further defined to avoid the possibility of conflicting possible winning strategies when making the decision to either hold or redraw at least one said playing element.

In another aspect, there is provided a gaming system comprising a display and a user interface in communication with a game controller for providing a hold and draw style game in which a plurality of playing elements are selected and if a particular combination of playing elements occurs the gaming system awards an award, the gaming system further comprising memory containing definitions of a plurality of playing elements, wherein the game controller:

selects and presents a plurality of playing elements in a selection process during which one or more playing elements are selected and presented to a player;
either holds or redraws at least one of the playing elements dependent on operation of the user interface by the player; and
defines each of the plurality of outcomes as the playing elements in a pattern within the plurality of playing elements as displayed, wherein at least two patterns have at least one playing element in common,
wherein the outcomes are further defined to avoid the possibility of conflicting possible winning strategies when completing the step of either holding or redrawing at least one of the playing elements.

In another aspect, there is provided a computer program product for a computational controller, the computer program product having instructions suitable to cause the computational controller to implement in a gaming system any one of the methods defined in the preceding paragraphs. In another aspect, the invention relates to signals suitable for controlling a display to show a game implemented by the computer program product.

Further aspects of the present invention will become apparent from the following description, given by way of example with reference to the accompanying drawings and from the appended claims.

### BRIEF DESCRIPTION OF THE DRAWINGS

FIG. 1: shows diagrammatically, a view of a gaming machine suitable for implementing the present invention.

FIG. 2: shows a block diagram of a gaming system suitable for implementing the present invention.

FIG. 3: shows a flow diagram of a process to be implemented by the gaming system of FIG. 2 according to an embodiment of the present invention.

FIG. 4: shows a screen layout at the commencement of a game according to an embodiment of the present invention.

FIG. 5: shows a screen layout at an interim point of the game;

FIG. 6: shows a screen layout at a concluding point of the game;

FIG. 7: shows diagrammatically a gaming system incorporating a gaming table in according to another embodiment of the present invention;

FIGS. 8-14: show screen layouts according to alternative embodiments of the present invention.

FIG. 15: shows a gaming machine in accordance with a further embodiment of the present invention, including an electromechanical display.

FIG. 16: shows a linked gaming system in accordance with a further embodiment of the present invention.

FIG. 17: shows two possible reel strips for two embodiments of the present invention that display playing elements on spinning reels to form part of an outcome in accordance with an aspect of the present invention.

FIG. 18: shows a block diagram representation of one embodiment of a control system suitable for use with the gaming system shown in FIG. 7.

### DETAILED DESCRIPTION

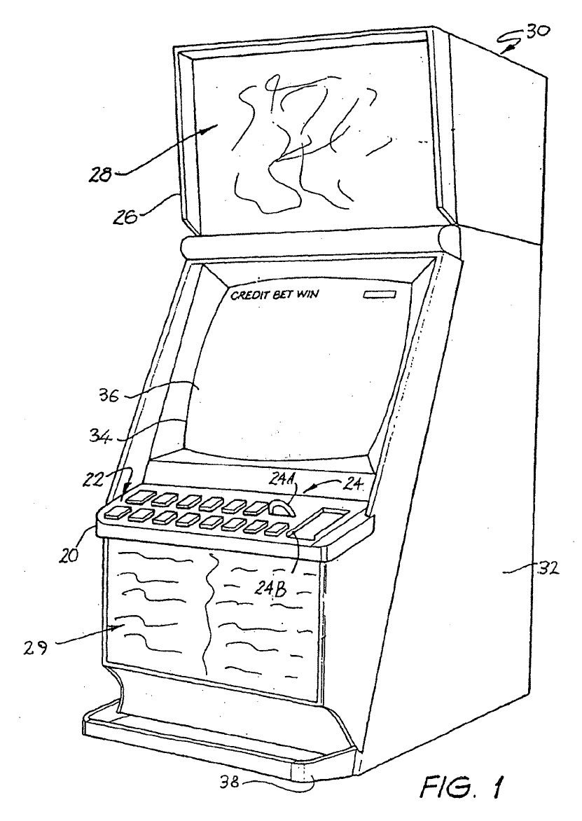

In FIG. 1 of the accompanying drawings, a gaming machine suitable for implementing embodiments of the present invention is generally referenced by arrow 30. The gaming machine 30 is one example of a gaming system that is suitable to implement the present invention. The architecture of the gaming machine 30 includes a console 32 having a display 34 on which is displayed representations of a game 36 in accordance with the present invention, that can be played by a player. A mid-trim 20 of the gaming machine 30 houses a bank of buttons 22 for enabling a player to play the game 36. The mid-trim 20 also houses a credit input mechanism 24 including a coin input chute 24A and a bill collector 24B. A top box 26 may carry artwork 28, including for example, pay tables and details of bonus awards and other information or images relating to the game. Further artwork and/or information may be provided on the front panel 29 of the console 32. A coin tray 38 is mounted beneath the console 32 for cash payouts from the gaming machine 30.

The display 34 shown in FIG. 1 is in the form of a video display unit, particularly a cathode ray tube screen device. Alternatively, the display 34 may be a liquid crystal display, plasma screen, any other suitable video display unit, or the visible portion of an electromechanical device. In this latter respect, the present invention may be implemented using a stepper motor to control the position of physical reels. The top box 26 may also be a display, for example a video display unit, which may be the same type as the display 34, or a different type of display.

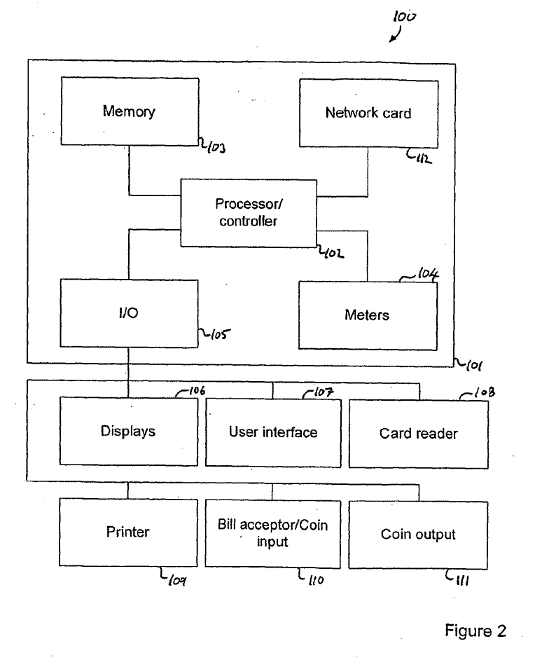

FIG. 2 shows a block diagram of a gaming system, generally referenced by arrow 100, suitable for implementing embodiments of the present invention. The gaming system 100 may be, for example, a standalone gaming machine of the type shown in FIG. 1. However, the gaming system 100 may be a networked gaming machine or have distributed hardware and software components that communicate directly or through a network. Accordingly, different reference numerals have been used in FIG. 2 from FIG. 1 for components that may be equivalent.

The gaming system 100 may include a game controller 101, which in the illustrated example includes a microprocessor, microcontroller, programmable logic device or other computational device 102. Instructions and data to control operation of the computational device 102 are stored in a memory 103, which is in data communication with the computational device 102. Typically, the gaming system 100 will include both volatile and non-volatile memory and more than one of each type of memory, with such memories being collectively represented by the memory 103. In addition, the functions of the computational device 102 may be separated into separate devices. The instructions to cause the game controller 101 to implement the present invention will be stored in the memory 103.

The gaming system may include meters 104 for the purposes of regulatory compliance and also include input/output interface 105 for communicating with the peripheral devices of the gaming system 100. The input/output interface 105 may itself be an intelligent device and may have its own memory for instructions and data. In FIG. 2, the peripheral devices that communicate with the controller are one or more displays 106, user interfaces 107, card readers 108, printers 109, a bill acceptor and/or coin input mechanism 110 and a coin output mechanism 111. The gaming system may include a ticket reader in addition to, or instead of the bill acceptor/coin input 100 and/or the card reader 108. One or more of the peripheral devices may be intelligent peripheral devices which may have their own memory 103 containing instructions and data and may complete instructions in addition to, or instead of, the game controller 101.

In addition, the gaming system 100 may include a communications interface, for example a network card 112 to communicate with a network for such purposes as sending status information, accounting information and the like to a central controller, allowing communication from the central controller to the gaming system 100 or for other purposes. In one embodiment, the functions of the computational device 102 may be split between a remote device and a local device, for example with game outcomes generated remotely and game graphics for the display 106 generated locally to the display. In another embodiment, the peripheral devices only may be provided locally with a network interface, in which case all, or nearly all intelligent devices may be located remotely.

In a preferred embodiment of the present invention as currently contemplated, the gaming system 100 is a gaming machine of a type commonly found in casinos and other gaming venues.

In the following description of the present invention, a card style game is described. Consistent with this, the term “hand” has been used to describe a game outcome that is evaluated for the occurrence of a winning hand. The present invention however, extends to games that do not use cards to define outcomes in the form of hands.

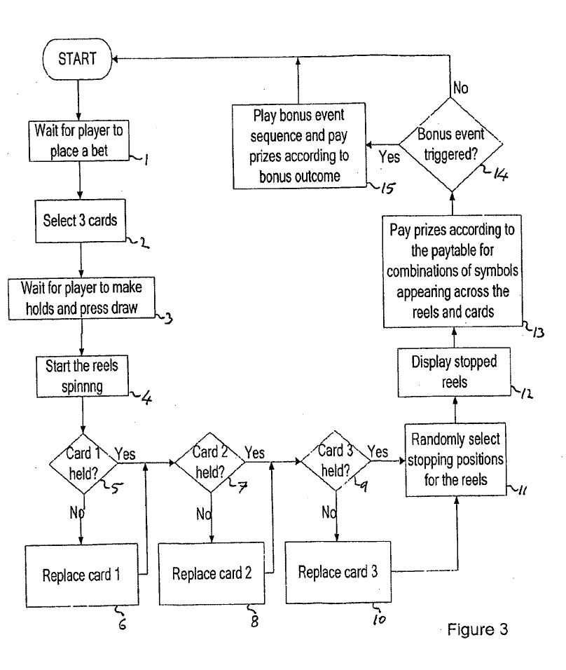

FIG. 3 shows a flow chart of a process to be followed under the control of the gaming system 100, in accordance with one embodiment of the present invention. After the gaming system 100 has been initialised and the necessary boot and game software loading procedures have been completed, the game process according to the present invention commences at step 1, with a gaming system 100 waiting for the player to place a bet.

The player may use the player interface 107 to place a bet and typically one of the meters 104 is reduced by an amount corresponding to the bet amount. Credit may be established by the player using the card reader 108, bill acceptor/coin input mechanism 110, through the use of an account maintained by a central computer system (not shown) and accessed through the network card 112, or otherwise.

In placing the bet, the player preferably specifies at least one of how many hands they wish to play and the bet per hand, optionally allowing different bets for each hand. However, the gaming system 100 may equally require play at a set number of hands and/or at a set bet per hand.

In step 2, the gaming system 100 randomly selects three items, in this embodiment playing cards from a predefined deck of cards. These are displayed to the player on at least one of the displays 106. Throughout the following description, reference is made to the playing elements or playing items being cards, representing the preferred form of the invention as presently contemplated. However, the particular form of the playing elements/playing items may be varied. For example, the three playing elements/items may instead be represented by spinning reels, with only one symbol position in the reel being displayed.

In step 3, the player is given the option to hold one or more of the three dealt cards. This may be achieved, for example, by the player selecting a button or touch pad in the user interface 107. The player could select to hold zero, one, two or all three cards. In one embodiment, the gaming system 100 may automatically hold one or more cards or suggest one or more cards to hold according to a calculation of the card most likely to result in a win or a maximum win and/or in accordance with an historical record of a player's past strategy. The player is then given the option to override the gaming system's selection. The user interface 107 preferably includes a “draw” button or equivalent, which the player presses after they have completed their selection of cards to hold, or have approved the strategy suggested by the gaming system 100 (which may be the default position). Once the draw button has been depressed, the process proceeds to step 4.

In step 4, the gaming system 100 displays to the user, using one of the displays 106, a representation of two spinning reels. The spinning reels may have symbols on them from the same symbol set as the cards. While the reels are still spinning, the process progresses to step 5, in which a determination is made whether a first card in the three dealt cards has been held by the player. If the first card was not held, then a replacement card is drawn and preferably displayed where the first card was originally displayed (step 6). In the preferred form of this embodiment, the replacement card is drawn from the same deck of cards as the cards were drawn from in step 2. Alternatively, a second deck may be used, for example a complete deck including the cards that were drawn in step 2. The process then moves on to step 7. If the first card was held, the process proceeds from step 5 directly to step 7.

The process described in relation to the first card and steps 5 and 6 is repeated for the second and third cards in steps 7, 8, 9 and 10. In the preferred form of this embodiment, steps 6, 8 and 10 all involve drawing from the same deck of cards, although this is not essential.

After all cards that were not held have been replaced, the process proceeds to step 11, in which the controller 101 randomly selects the stopping position of the two reels. Typically the determination is made by a random number generator in the computational device 102. However, the determination could be made elsewhere and communicated to the controller 101, for example through the network card 112. Once the stopping position of the reels has been determined, the process proceeds to step 12, which involves displaying to the player, in at least one of the displays 106, the stopped position of the reels, which in the examples shown in the accompanying drawings, reveals five symbols in a column.

In step 13, an evaluation is made as to whether a winning combination of cards appears in any hand that the player has purchased when they made their bet in step 1. The way in which the multiple hands are determined is explained later herein. The gaming system 100 makes an award, if any is due, according to the pay scale for any winning hands in a bought hand and the process then proceeds to step 14.

In step 14, the gaming system 100 determines whether a bonus event has been triggered and if so the bonus event is played out in step 15, including making an additional applicable award. A bonus event may be triggered in any number of different ways, for example by the display of one or a combination of special symbols, the accumulation of special symbols over a number of game plays, the accumulation of either a predetermined or mystery variable amount, for example credits wagered, by the gaming system 100 or a collection of gaming systems 100, or a random determination, based, for example of a 1 in 100 chance of a bonus event being triggered for each play of the base game. Also, the bonus event may be any event required for the particular implementation of the game.

At the conclusion of the bonus event, if one was triggered, the gaming system 100 pays any prizes awarded in the bonus event and then the process returns to the start. Of course if a bonus event was not triggered, the process proceeds directly from step 14 back to the start. The provision of a bonus game is optional and if one is not provided, then steps 14 and 15 may be omitted from the process shown in FIG. 3.

In one aspect, the present invention involves the use of a pay line concept in a hold and draw style card game, which may, for example be played according to traditional poker rules with a deck of cards. FIG. 17A shows a reel strip that may be used if poker rules are applied, there being 52 symbol positions on the reel, one taken by a representation of each card in a standard deck of cards. Alternatively, the present invention involves the use of a hold and draw concept in a pay line game, which may pay for winning combinations occurring left to right and optionally also right to left or anywhere along a pay line. FIG. 17B shows a reel strip that may be used if the game is played with a spinning reel pay structure. The available pay lines are defined by the various combinations of hands that are available that each use one of the symbols from a spinning reel in combination with the symbols from the other spinning reel and the dealt cards. For example, for a game of the present invention that has two spinning reels, each with five displayed symbol positions and three cards, 25 possible pay lines can be defined as shown in Tables 1-5 herein.

Alternatively any or all of the positions in the game could be dealt from pre-defined decks of cards (traditional decks for poker or created decks for spinning reel pay structures). This could be with or without replacement. Also there could be separate decks for different positions or one deck may be used to deal without replacement across multiple positions in the game.

In Tables 1-5, the possible lines have been numbered 1 to 25 with the number appearing in the left-most column of the tables. Each pay line is identified by an “x” in each of the 2^{nd}, 3^{rd}, 4^{th}, 5^{th} and 6^{th} columns of the tables. Each table describes five pay lines.

The 3^{rd}, 4^{th} and 5^{th} columns represent the three dealt cards, which are fixed and this is represented in Tables 1-5 by having an “x” in one position only in each of these columns. The 6^{th} column represents the second spinning reel, with five symbol positions.

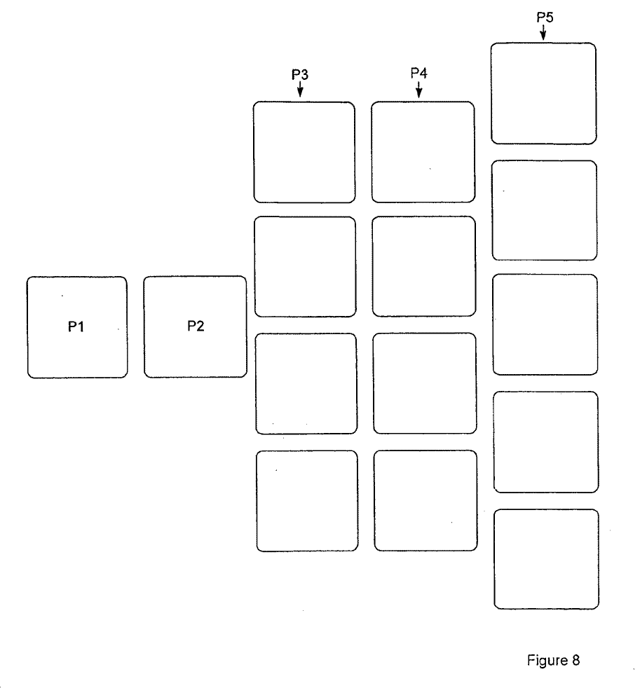

Tables 1-5 have been drawn to reflect a currently contemplated preferred display format for the present invention, which has a reel to either side of the three dealt cards. However, the reels could be also be located elsewhere, for example side by side or positioned in the two gaps between the three cards without affecting the operation of the game. Some alternative display formats are described in more detail later herein with reference to FIGS. 8 to 14.

TABLE 1
pay lines 1 to 5

| Lines | Relevant positions | | | | |
|---|---|---|---|---|---|
| 4 | x | | | | |
| 2 | x | | | | |
| 1 | x | x | x | x | x |
| 3 | x | | | | |
| 5 | x | | | | |

TABLE 2
pay lines 6 to 10

| Lines | Relevant positions | | | | |
|---|---|---|---|---|---|
| 9 | x | | | | |
| 7 | x | | | | x |
| 6 | x | x | x | x | |
| 8 | x | | | | |
| 10 | x | | | | |

TABLE 3
pay lines 11 to 15

| Lines | Relevant positions | | | | |
|---|---|---|---|---|---|
| 14 | x | | | | |
| 12 | x | | | | |
| 11 | x | x | x | x | |
| 13 | x | | | | x |
| 15 | x | | | | |

TABLE 4
pay lines 16 to 20

| Lines | Relevant positions | | | | |
|---|---|---|---|---|---|
| 19 | x | | | | x |
| 17 | x | | | | |
| 16 | x | x | x | x | |
| 18 | x | | | | |
| 20 | x | | | | |

TABLE 5
pay lines 21 to 25

| Lines | Relevant positions | | | | |
|---|---|---|---|---|---|
| 24 | x | | | | |
| 22 | x | | | | |
| 21 | x | x | x | x | |
| 23 | x | | | | |
| 25 | x | | | | x |

Therefore, when the player places a bet in step 1 of the process shown in FIG. 3, the player is buying one or more of the pay lines represented in Tables 1-5 and buying a particular size bet for each bought pay line. The gaming system 100 may provide set combinations of pay lines, for example providing the options of 1 line, 5 lines, 10 lines, 15 lines and 25 lines, Playing each line may require the wager of one credit. In this example, the 1 line bet may be pay line 1, the 5 line bet pay lines 1 to 5 as shown in Table 1, the 10 line bet pay lines 1 to 10 as shown in tables 1 and 2 combined and so on. Typically, the player selects the required combination of play lines using a button on the bank of buttons 22. Alternatively, the player may be able to select each pay line individually, in which case the display 14 may include a touch screen allowing the player to select and deselect each pay line.

In a further alternative, the player may be able to select one or more symbol positions from each of the spinning reels and the gaming system 100 may select, in effect, all the pay lines that use the selected symbol positions. For example, if the player selected two symbol positions in each spinning reel, then four pay lines are effectively defined. If the player selected three pay lines in one reel and two in the other, then six lines are effectively defined. If all symbol positions are selected, then all twenty-five lines are effectively defined.

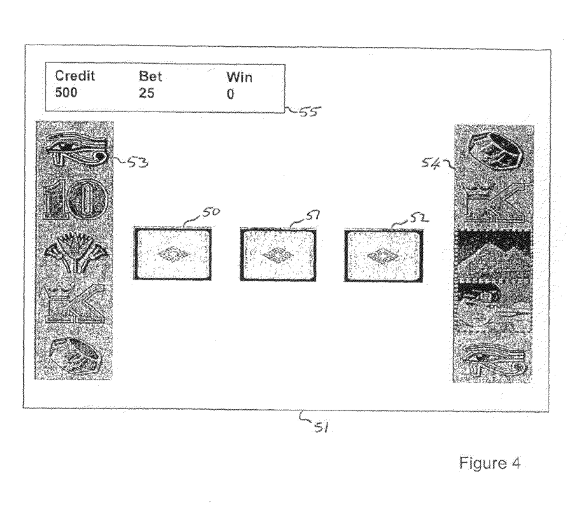

FIGS. 4, 5 and 6 show representations of possible screen displays S1, S2, S3 respectively in accordance with this embodiment of the present invention, which has three card positions 50, 51, 52 and two spinning reels 53, 54. The screen display also includes a meter display 55, in which the available credit, bet size and win amount is displayed. Of course, the screen display will typically include further representations, most notably artistic works, animations and/or video clips, these being omitted in the accompanying figures for the purposes of clarity.

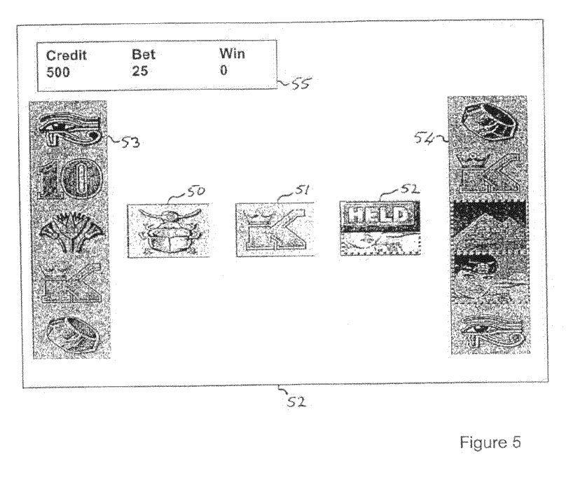

In screen display S1, the player's attention is drawn to the three card positions 50, 51, and 52 by dulling the spinning reels 53 and 54. The three cards in the three card positions 50, 51, 52 are then revealed to the player and the player is given the option to hold zero, one, two or all three of the revealed cards. FIG. 5 shows a screen display S2 showing the word “HELD” over the card position 52, indicating that the player has held the card displayed in that position. In the example shown, the card in card position 52 is a wild card i.e. a card that substitutes for any symbol. Of course, the player may choose to either hold cards as described above, or to discard cards, in which case the cards that are not selected are deemed to be held.

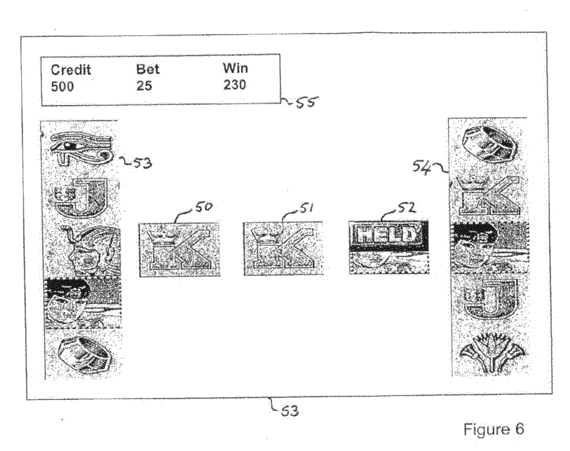

Next, the two cards that were not held, namely the cards in card positions 50 and 51, are replaced and the spinning reels 53, 54 are spun and stopped to reveal the hands available. FIG. 6 shows a screen display at the completion of this process. The cards in card positions 50 and 51 have been replaced (the drawing of new cards resulting in a card with the same face being displayed in card position 51) and the spinning reels 53, 54 have been spun to a random position and are now highlighted. The spinning reels 53, 54 could alternatively have been spun earlier so that the player could see them (assuming they are revealed) before making the decision to hold or redraw the cards in symbol positions 50-52.

In the example shown in FIG. 6, the player has bet 25 lines in a game that has a pay table that awards 100 credits for five kings and 10 credits for four kings from left to right. Therefore, a win of 230 credits is awarded for the combination of symbols displayed in screen display S3. This win occurred due to the display in two pay lines of five kings (pay lines 3 and 8) and the display in three pay lines of four kings (lines 13, 18 and 23).

While the game described herein above in relation to FIGS. 4 to 6 may be particularly suited to a hold and draw style game, the game could also be implemented without giving the option the player to redraw any cards/respin any reels. in this case, all five reels 50-54 could be spun at the same or at different times and then evaluated for the occurrence of a winning outcome.

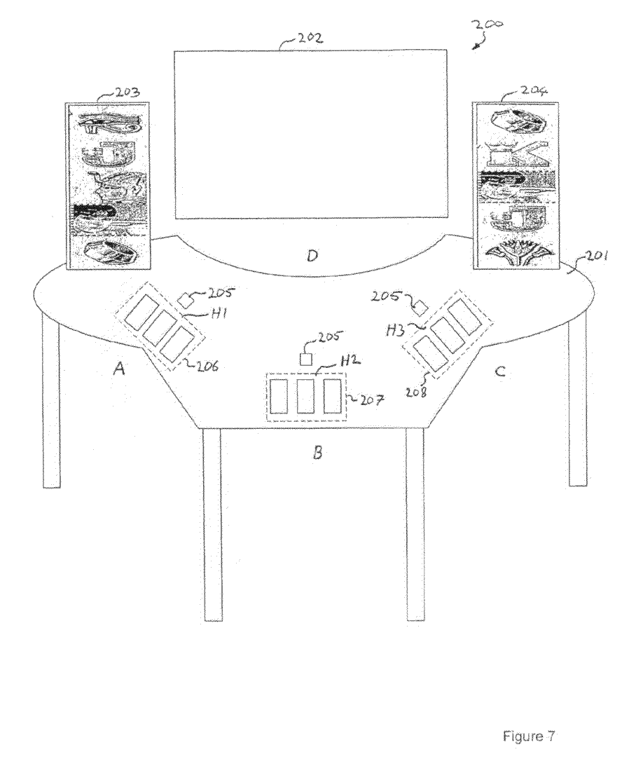

FIG. 7 shows a gaming system 200 according to an alternative embodiment of the present invention. The gaming system 200 may have the computational architecture of the gaming system 100, but is implemented as a table game. The game controller 101 may therefore control the displays of the gaming system 200 to implement the game, including making the required random selection of symbols to be displayed on the displays, evaluating game outcomes for the occurrence of one or more winning outcomes and indicate and optionally implement the required pay out, if any, to each player of the gaming system 200.

The table game, as well as the game formed entirely by a computational gaming system, may have game rules that implement a poker game, with associated pay rules. In this embodiment, the outcomes of the game are compared with winning hands and awards awarded according to an appropriate pay table. Alternatively, the game may be more like that of a traditional spinning reel game with a pay table defining wins for the spinning up/dealing of certain combinations of symbols/cards, which are often, but not necessarily read from left to right only commencing from the first reel.

In the table game version shown there is space for three players A, B and C at a table 201. A first screen 202 may be provided to show attract sequences, pay tables, animations, video clips and similar information. A second screen 203 and a third screen 204 may be provided to show representations of spinning reels. The representations of spinning reels may alternatively both be provided on the first screen 202.

The game may be played by one, two, or all three of the players A, B, C. For the remainder of the description of this embodiment it is assumed that all three players are participating in the game. Each player A, B, C may be dealt partial hands H1, H2, H3 respectively, each partial hand consisting of three cards. The dealing may be performed by a dealer D, which may be person or a mechanical dealer, and each player A, B, C may then be given the option to hold any of the cards. Any cards that are not held are then replaced by the dealer D.

Next, the reels displayed on screens 203 and 204 are spun to reveal the final possible hands, which are made up of combinations of the symbols displayed on screens 203 and 204 with the cards in partial hands H1, H2 and H3 after any cards that were not held have been replaced. The number of hands available may be variable and dependent on a wager by a player. Alternatively, the wager may be fixed to an amount that allows all 25 possible hands to be played.

Although it may be possible for the dealer D to visually inspect the display screens 203, 204 and the partial hands H1, H2 and H3 and then calculate any award that may be payable, it is expected that this process will be overly slow and open to error.

Therefore, the gaming system 200 may further include a radio frequency identification device (RFID) reader 205 and the physical cards may have RFID chips in them. As shown in FIG. 7, in the preferred embodiment as presently contemplated three RFD readers 205 are provided, one for each player A, B, C. The dealer D, may then use the RFID readers 205 to identify to the gaming system 200 which cards have been dealt to each player. This enables the gaming system 200 to compute the win, if any, of each player A, B, C after the spinning reels in displays 203, 204 have been stopped. In a further alternative embodiment, RFID readers 205 may be located to read each of the cards in the partial hands H1, H2, H3 after they have been placed on the table 201. In this further alternative embodiment the dealer D will place the cards on the table in designated positions where the RFID readers 205 are located.

Alternative methods of identifying the cards dealt by the dealer D may be used, including using optical scanning, magnetic detectors or by the dealer entering the cards that have been dealt to each player using a keypad or other input device. In the latter case, in many embodiments of the present invention, the dealer D need only input the final partial hands of each player A, B, C respectively in order to allow the gaming system 200 to determine what awards, if any, are payable.

In an alternative embodiment to the gaming system 200, additional screens 206, 207, and 208 (shown in outline in FIG. 7) may be provided, one for each player A, B, C. In this embodiment the gaming system displays cards to each player in a similar manner to the display 16 for the gaming machine 30. If the game is implemented as a hold and draw game, each player can then use touch pads on the screen to select what cards to hold and if applicable, specify their bet. Similarly, the displays 203, 204 may be omitted and the entire game played with physical cards. In the game that is played with physical cards, there may be a complete set of cards available for each position in each partial hand H1, H2, H3 and for each of the five positions that complete the hands. Alternatively, the cards may all be dealt from a single set of cards, which may comprise multiple decks, without replacement. In a further alternative, the partial hands H1, H2, H3 may be from one set and the remainder of cards dealt from another set.

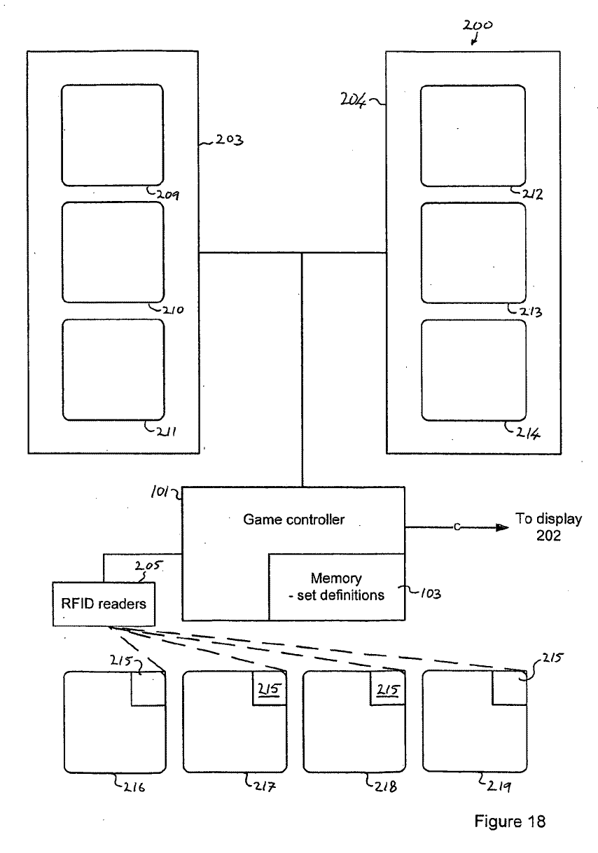

FIG. 18 shows a block diagram showing parts of the gaming system 200. The game controller 101 communicates with the second and third displays 203 and 204 and causes the displays 203, 204 to each display, in this example three playing elements 209-214. The game controller 101 also receives an indication of what physical playing elements have been dealt from the RFID readers 205, which read RFID chips 215 that have been provided in physical playing elements 216-219. Therefore, in this example, each complete outcome is formed by six playing elements, the player is dealt four physical playing elements and is allowed to redraw any one or more of those physical playing elements. Up to nine outcomes are formed by combining the playing elements 209-214 with the playing elements 216-219.

The memory 103 of the game controller 101 includes a definition of one or more sets of playing elements. In one embodiment of the invention, all the playing elements 209-214 and physical playing elements 216-219 are effectively dealt from the same set of playing elements without replacement. Taking the example where the playing elements are cards in a standard 52 card deck, the game controller 101 may receive an indication of the cards 216-219 that are originally dealt and any replacement cards for those that were redrawn. The game controller may then remove these cards from eligibility for selection as one of the playing elements 209-214.

The display 202 is not shown in FIG. 18, the communication of the game controller with the display 202 being represented by arrow C. A separate processor/controller may directly control the display 202 and communicate with the rest of the game controller 101 through a suitable communication channel.

In one embodiment, the player places a bet that determines the number of hands available before they are dealt their first three cards. In an alternative embodiment, the player places an ante-bet before the first three cards are dealt and can then choose how many hands to play after they have seen the first three cards, in which case an additional bet may be payable on a per line basis, or the player can choose no lines, in which case they forfeit their ante-bet. In addition, the player may have to set the bet per hand at the commencement of the game or be allowed to vary the bet from an ante after they have seen the first three cards. The number and type of symbols displayed on the spinning reels and/or on the physical cards may be varied to achieve a required pay ratio for each embodiment.

In a still further alternative embodiment of the invention, a first dealing/spin of sufficient symbols to define a complete outcome is completed and evaluated for a win. If a win occurs, the player is paid the prize. If a non-win occurs, the player can choose to place a further bet and hold one or more symbols that are eligible to be held and respin/redraw the others.

Like the gaming machine embodiment, the gaming system 200 may recommend to a player which cards to hold. This may be achieved by a display or other indicator, for example a flashing light provided on the table 201 and positioned above a location to which the cards are dealt.

Due to the separation of the screens, the gaming system 200 may first spin the reel on the first screen and then spin the reel on the second screen after the first reel has stopped. The second reel may spin long enough to enable a player to view the combinations on the first reel, look down at the three cards that they have been dealt and then look over to the second screen. Optionally, the length of time that the reel on the second screen spins may depend on whether any of the players have a winning outcome. If a player has won, the second reel may spin longer than if no players have won. In addition, if a player has potentially won a significant prize, the reels may spin even longer still in order to increase the suspense.

In any of the embodiments of the present invention described herein, instead of using cards and/or spinning reels to define the playing elements of the game, other game pieces capable of singly or collectively generating a series of random events may be used, for example dice. In a table game implementation there could be a die for each playing element, the die performing a like function to the deck of cards or spinning reels described herein above. Of course, the type of table required will depend on the game pieces that are used.

One aspect of the present invention includes a game in which physical game pieces, and playing elements randomly selected and displayed on a display, are combined into one or more outcomes consisting of two or more playing elements. The outcome or outcomes are then evaluated for the presence of a winning combination. In the currently contemplated preferred form of this aspect of the invention the game involves a hold and draw style game as described herein, although this is not essential. The physical game pieces may for example be cards or die, and the display may for example be a video display or an electromechanical display under the control of a game controller.

Although the foregoing description has used a game, which has three cards and two reels with each reel having five symbol positions, those skilled in the relevant arts will appreciate that any number of cards and any number of reels may be provided. In particular, one spinning reel may be used or three or more spinning reels may be used and one or two cards may be used or four or more cards. The larger the amount of reels that are used and the larger the number of symbol positions on each reel, then the more hands that may be made available to be played.

FIG. 8 shows an example alternative screen display for a game and gaming system according to the present invention. In this example, two playing elements P1, P2 are displayed and optionally either held or replaced according to a player selection. Then, three sets P3, P4 and P5 of playing elements are selected and displayed. Sets P3 and P4 consist of four displayed playing elements and set P5 consists of five displayed playing elements. Therefore, in this embodiment up to 80 combinations of playing elements can be defined, each of which consist of the two playing elements P1 and P2 and a combination of one playing element from each of the sets P3-P5.

In addition, the player may be dealt more than one hand at the outset and each spinning reel could combine with any one of the hands. For example, if the player was provided two hands of three cards and two reels were displayed each with five displayed positions, then up to 50 pay lines would be available, consisting of 25 hands having one hand of three cards in common and 25 hands having the other hand of three cards in common. This number will continue to increase proportionally with the number of hands that are dealt.

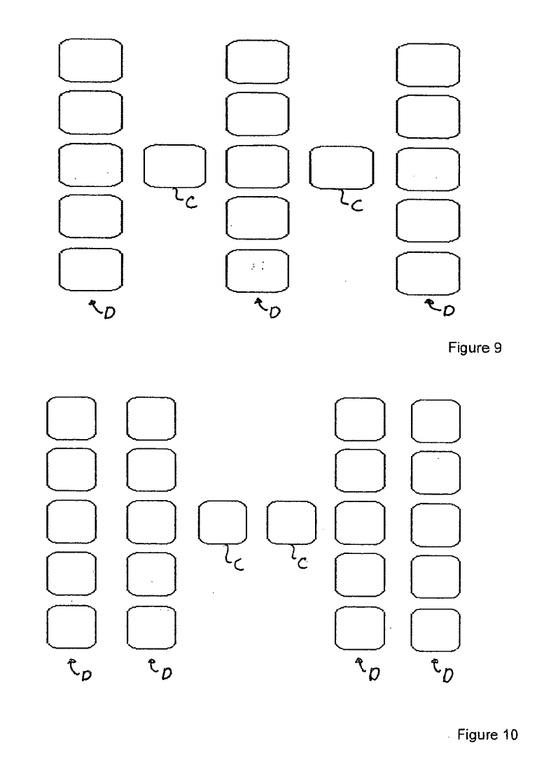

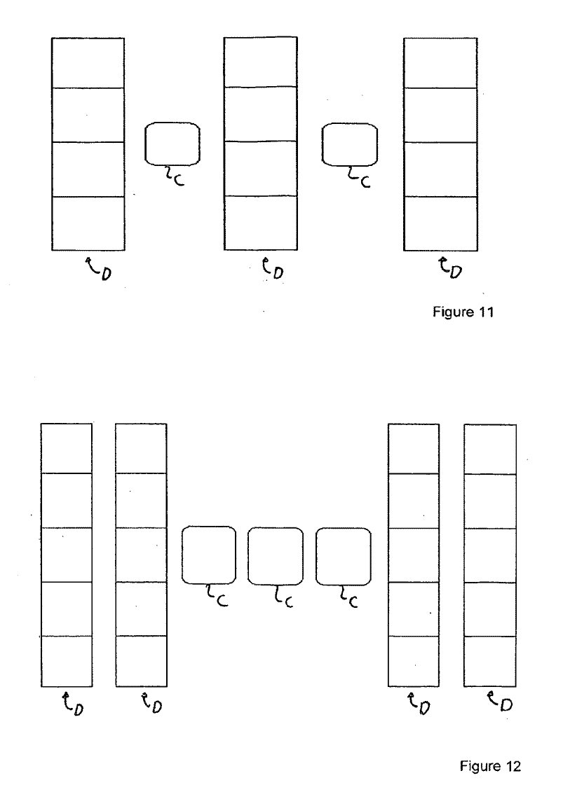

FIGS. 9 to 12 show further alternative screen displays. FIGS. 9 and 10 show embodiments in which individually drawn playing elements are used and FIGS. 11 and 12 show embodiments in which the playing elements are selected by selecting the stopping position of spinning reels. In FIGS. 9 and 11 up to 125 and 64 outcomes respectively can be identified from the symbols and in FIGS. 10 and 12 up to 625 outcomes can be identified. Even with 625 outcomes defined, the displayed symbols may still be easier to view and evaluate than if a much lesser number of individual hands were displayed on screen.

In each screen display shown in FIGS. 9 to 12, some playing elements are common to every outcome of the game and these are shown by playing elements C, the remaining playing elements differ (although some may be the same, particularly if each individual playing element is randomly determined instead of being spun up on a reel) to create multiple outcomes and these are represented by arrows D. Where a hold or redraw option is provided, then this may be provided in respect of at least one of the playing elements C.

Referring in particular to FIG. 9, a player may be initially dealt anywhere between one and five cards (or other playing elements), and then a decision is made whether to hold or redraw one or more of those cards. Where one card is dealt, this may be one of the playing elements C, which is then either held or redrawn and the remainder of the cards drawn to determine the game outcomes. If two cards were dealt, they may suitably be both the playing elements C, one or both of which may be able to be redrawn. If three cards were dealt, for example the central three cards, the central card can still be held or redrawn. If it is held, then only the cards above or below that card are redrawn (if it is a spinning reel display, then the centre position of that reel then remains unchanged. A similar process is completed for the fourth and fifth cards if they can be held or redrawn. The options described in this paragraph also apply to embodiments of the invention other than that shown in FIG. 9.

In one embodiment, the position of the playing elements may be dynamic. Again using the card and spinning reel example, a player may be dealt five cards and given the choice to hold or redraw any of them (the choice could alternatively be made or recommended by the gaming system). Assuming that up to 125 outcomes are required as shown in FIG. 9, if one or two cards are held, then these may be deemed to be the playing elements C. If three or more cards are held, then the central position of one or more of the reels becomes fixed.

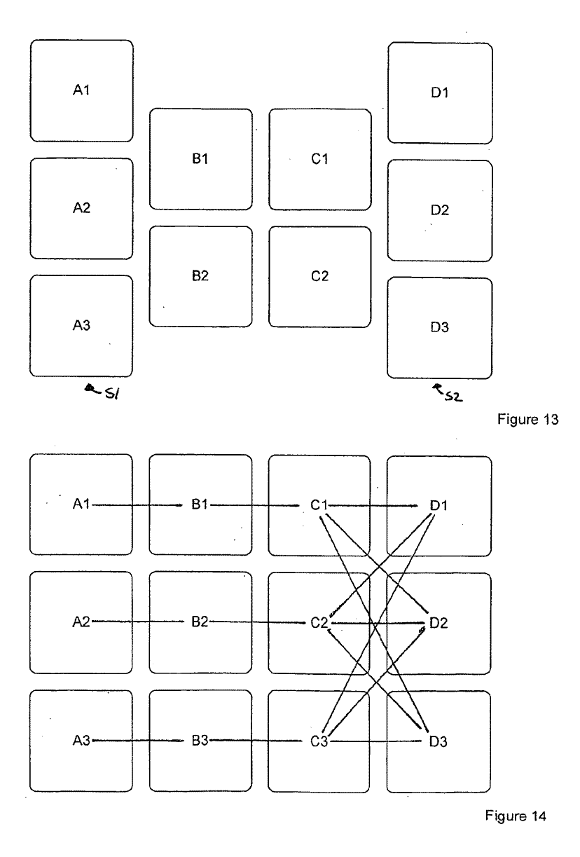

FIGS. 13 and 14 show diagrammatically possible alternative layouts of cards and reels where a player is dealt a plurality of initial partial hands. In each combination four columns A-D are shown, each column displaying between 2 and 4 cards. Combinations may be formed right to left in addition to left to right, or alternatively the order of the cards in a combination may be irrelevant.

In FIG. 13, two partial hands are dealt to a player comprising cards B1, C1 and cards B2, C2 and then three cards are dealt physically or automatically, for example spun up on two spinning reels S1, S2, comprising cards A1, A2, A3 and cards D1, D2, D3 respectively. All game outcomes have either cards B1 and C1 or cards B2 and C2 in common. Alternatively, the partial hands and the spinning reels may be reversed, so that three hands are dealt and each spinning reel presents two cards.

For the layout of playing elements shown in FIG. 14, three partial hands are dealt and one, two or three spinning reels or dealt columns of playing elements complete the available hands. The outcomes are shown in FIG. 14 for the case where the partial hands, each consist of three playing elements A1-C1, A2-C2 and A3-C3 and one spinning reel or dealt column D1-D3 is provided. There are therefore nine outcomes.

As mentioned above with particular reference to FIGS. 9 and 10, the spinning reels may be replaced by individually random drawn playing elements, for example cards. This may also allow additional potential winning combinations, the additional winning combinations defined by a combination of the random drawn playing elements that replaced the spinning reels.

Overall, in a game where the outcome are defined from left to right across the displayed symbol positions, the maximum number of possible outcomes available is the product of the number of symbol positions provided in each column or other arrangement of symbol positions that can be combined in any permutation to form the outcomes, which is then multiplied by the number of alternative sets of symbol positions that can be held or redrawn, which are represented in rows in the examples in the accompanying drawings. Therefore, the number of outcomes (0) may be expressed as O=k.P, where k is the number of alternative sets of symbol positions that can be held or redrawn and P is the product of symbol positions that can be combined in any permutation to form the outcomes.

For example, in the arrangement of symbol positions shown in FIGS. 4 to 7, k is 1 and P is 25. In the arrangement shown in FIG. 13 k is 2 and P is 9. If the game also defines outcomes from right to left across the displayed symbol positions, then the number of possible outcomes is doubled. If the number of symbol positions in each column (or other functionally equivalent arrangement) is equal, then P=ŜC, where S is the number of symbols in the columns and C is the number of columns.

The player may be able to select the particular hands that they wish to play, either at the outset of the activation of a game, or after the first partial hand has been dealt. This could be achieved in a similar manner to the selection of pay lines as is known for multiple pay line gaming machines. Alternatively, the player may select card positions in the spinning reels (or individually random drawn cards), with the paying combinations being all possible combinations that have one selected symbol in each reel. This selection process is like that described in international patent publication number WO 96/08799.

In a still further embodiment, the player may be dealt a first hand in which they are given the opportunity to hold any of the dealt cards, after which the cards that are not held are replaced and the player given a further opportunity to hold any of the replaced cards, after which the non held cards from the first and second dealings are replaced again. This process could stop after two dealings, or continue for a predetermined number of hands or until the player has held all three (or however many other cards are dealt) cards, whichever occurs first.

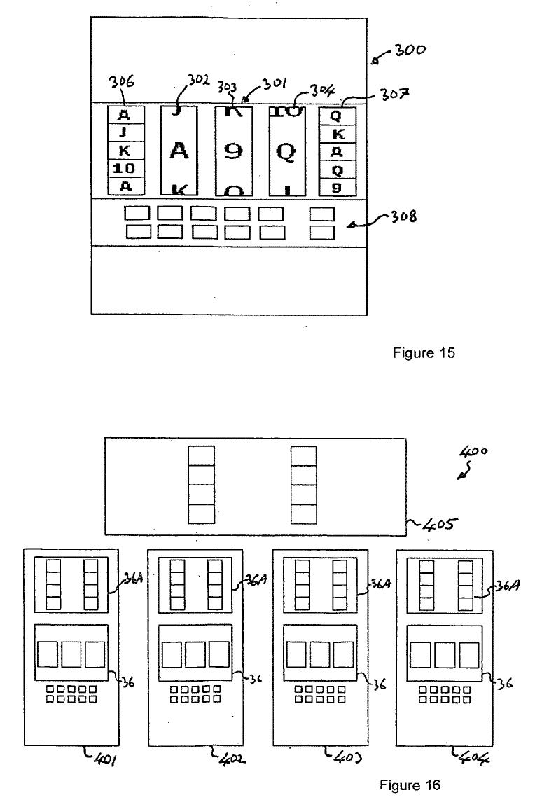

FIG. 15 shows an embodiment of the present invention implemented on a gaming machine 300 having an electromechanical display 301. Displays of this type are well known and are typically implemented using a stepper motor. The display 301 includes five physical reels 302-306. The game is played as described herein above with reference to the game played on the gaining machine 30. If a hold and redraw option is provided in the game, a player of the gaming machine 300 may use a player interface 308 to indicate whether to hold or redraw one or more of the symbols displayed on the physical reels 302-306, the reels being spun again if the player chooses to redraw.

The physical reels 302-304 shown in FIG. 14 have been adapted to display only a single symbol position when stopped. However, this is not necessary and instead multiple rows of symbols may be displayed, with only the centre row (or another single row) used to define a group of outcomes. Alternatively multiple groups of outcomes may be defined, one group associated with each row displayed on the physical reels 302-304 in the same was as described in relation to FIGS. 13 and 14. Also, one or more of the five reels 302-306, suitably both reels 305 and 306 could be video representations of spinning reels on a suitable display.

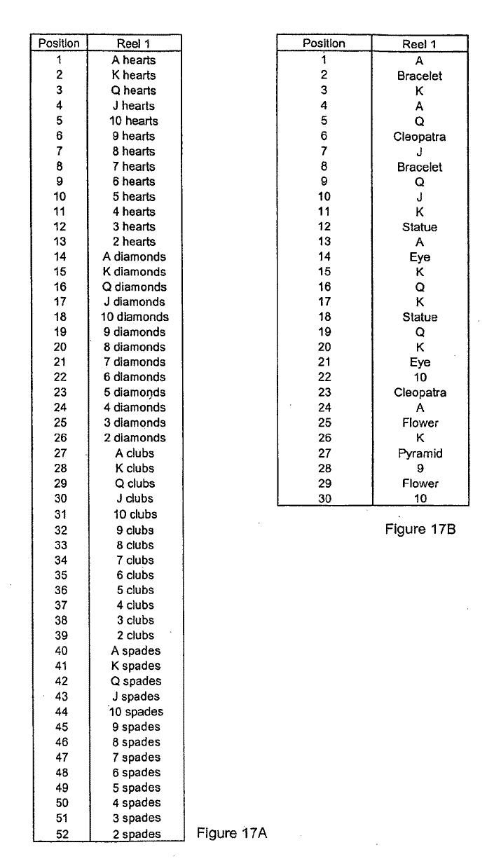

FIG. 16 shows a gaming system 400 including four linked gaming consoles 401-404 and an optional remote display 405. In this embodiment, multiple players can play the same game and have different outcomes in a similar manner to the table game described herein above, but using linked gaming machines instead of sitting at a table. The game will operate in the same way as the game described herein with reference to FIGS. 3 to 6, but with multiple players.

The gaming consoles 401-404 may have game controllers 101 (FIG. 2), or alternatively all or part of the game controllers 101 may be part of a server that services the gaming consoles 401-404. The gaming consoles 401-404 may be a bank of gaming machines at a single location within a gaming venue, may be separate gaming machines within a single location, or may be located across different gaming venues.

Where a remote display 405 is provided, preferably as many of the consoles 401-404 are located so that the players at the consoles 401-404 can see the remote display 405. Multiple remote displays 405 may be provided. Also, more or less than four consoles may participate in the game and the consoles may be dynamically configurable to play the game or may be dedicated to playing the game.

The gaming consoles may be gaming machines of the type shown in FIG. 1 and therefore like reference numerals are used for the components of the gaming consoles as were used for the gaming machine 30 where appropriate. The gaming consoles 401-404 each include a display 36 for displaying representations of playing elements that are equivalent to the playing elements displayed in symbol positions 50-52 in FIGS. 4 to 6. Another display 36A displays representations of spinning reels that are equivalent to the reels 53 and 54 shown in FIGS. 4 to 6. The representations of spinning reels are duplicated on the remote display 405.

The consoles 401-404 may each contribute to a linked progressive. The linked progressive may increment based on the wagers from each console. Each console may also, or instead, contribute to a stand-alone progressive for that console.

Both the table game implementation of the present invention and the linked gaming system implementation described herein allow multiple players. The multiple players may each be playing “against the house”, so that the winning or losing outcomes of one player are substantially independent of each other player. Some dependence on outcomes between the players will occur if the playing elements from at least one position in the game are dealt to all the players from a set of playing elements without replacement. In a linked gaming system played without replacement, each console may display what the other players have been dealt so that they may know what cards they can not receive in a redraw.

Alternatively, the players may be playing competitively against each other at least one some aspect. For example, only one player may win, being the player with the highest-ranking hand according to traditional poker rules. Alternatively, the winning player may be the one with the highest win according to a pay line pay structure, in which case they receive their win and the other players do not. Alternatively, the winning player may win a progressive prize. Those skilled in the relevant arts will appreciate that many alternative competitive play methods may be implemented using the present invention.

While the foregoing description has been provided by way of example of the preferred embodiments of the present invention as presently contemplated, which utilise gaming systems and machines and table games, those skilled in the relevant arts will appreciate that the present invention also may have application to internet gaming and/or to gaming over a telecommunications network where handsets are used to display game outcomes and receive player inputs.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of providing a game in which a player places a wager on a plurality of outcomes, a gaming apparatus forms the outcomes and if the outcomes represent one or more winning outcomes the gaming apparatus awards an award, the method comprising forming the outcomes by randomly selecting a plurality of playing elements, presenting each selected playing element in a single symbol position, and defining each outcome as a combination of the playing elements presented in a particular combination of symbol positions, wherein for every number of outcomes on which a wager is able to be staked, every one of the outcomes has at least one symbol position in common.

2. The method of claim 1, wherein for every number of outcomes on which a wager is able to be staked, every one of the outcomes has at least two symbol positions in common.

3. The method of claim 1, further comprising providing a player with a plurality of choices as to the number of outcomes on which to place a wager.

4. The method of claim 3, wherein a plurality of the playing elements are presented on one or more spinning reels and the process of randomly selecting a plurality of playing elements comprises randomly selecting the stopping position of the one or more spinning reels.

5. The method of claim 4, wherein there are two spinning reels that each present five playing elements, none of which are the playing elements common to every one of the outcomes.

6. The method of claim 5, wherein there are one or more further spinning reels, each of which present a single playing element that is common to every one of the outcomes.

7. The method of claim 1, wherein for the symbol positions that are common to every one of the plurality of outcomes, the method comprises either holding or redrawing the playing elements on those symbol positions dependent on a player input prior to forming the plurality of outcomes.

8. The method of claim 1, further comprising repeating the process for a plurality of players, wherein the playing elements in the symbol positions common to every one of the outcomes may differ between the players and a plurality of other symbol positions are constrained to present the same playing element for each player.

9. A method of providing a game in which a player places a wager on a plurality of paylines extending through an array of symbol positions, a gaming apparatus presents symbols in the symbol positions and if the presented symbols along at least one of the paylines represents a winning combination the gaming apparatus awards an award, the method comprising randomly selecting a plurality of symbols and presenting each selected symbol in a single symbol position, wherein every payline has at least one symbol position in common.

10. The method of claim 9, further comprising providing a player with a plurality of choices as to the number of paylines on which to place a wager.

11. A gaming system comprising a display and a user interface in communication with a game controller comprising a memory containing definitions of a plurality of playing elements, wherein the game controller provides a game on the gaming system by randomly selecting some of the playing elements and causing the display to present each selected playing element in a single symbol position, and by causing the award of an award if at least one of a plurality of outcomes represented by the presented symbols is a winning outcome, wherein for every possible game play of the game every one of the outcomes has at least one symbol position in common.

12. The gaming system of claim 11, wherein the number of outcomes is variable for different game plays, dependent on information received from the user interface.

13. The gaming system of claim 12, wherein the number of symbol positions is constant for every game play.

14. The gaming system of claim 11, comprising a plurality of displays and associated user interfaces, wherein the game controller replicates the symbol positions on the displays to thereby form a plurality of said games and for at least one but less than all of the symbol positions, displays the same playing element in the same symbol position in all of the games and for the other symbol positions independently determines the playing elements for that game.

15. The gaming system of claim 14, wherein for each game the playing elements selected for the symbol positions in common to every one of the outcomes are independently determined.

16. A gaming system comprising a display and a user interface in communication with a game controller comprising a memory containing definitions of a plurality of symbols, wherein the game controller provides a game on the gaming system by:
randomly selecting some of the symbols and causing the display to present each selected symbol in a single symbol position, the symbol positions defining an array through which a plurality of paylines are defined, and
causing the award of an award if the presented symbols along at least one of the paylines represents a winning combination, wherein for every possible game play of the game every one of the paylines has at least one symbol position in common.

17. The gaming system of claim 16, wherein the number of outcomes is variable for different game plays, dependent on information received from the user interface.

18. A method of providing a hold and draw style game in which a plurality of playing elements are randomly selected and if the selection of playing elements represents a winning combination an award is awarded, the method comprising:
a) selecting and presenting one or more playing elements;
b) either holding or redrawing at least one of the playing elements dependent on a player input;
c) selecting and presenting with the playing elements resulting from step b) a plurality of further playing elements;
d) identifying a plurality of outcomes, each outcome defined by a combination of playing elements within the playing elements and further playing elements, at least two of the outcomes having one or more playing elements resulting from the decision in step b) in common; and
e) if the plurality of outcomes of playing elements represents a winning combination, awarding an award.

19. The method of claim 18, wherein all of the outcomes have one or more playing elements resulting from the decision in step b) in common.

20. The method of claim 18, wherein the plurality of outcomes comprise a plurality of groups of outcomes, wherein every outcome in each group of outcomes has one or more playing elements resulting from the decision in step b) in common.

21. The method of claim 18 comprising completing step c) simultaneously with either step a) or step b).

22. The method of claim 18 comprising completing steps a) to c) in the order recited.

23. The method of claim 18, wherein the one or more common playing elements consist of all the playing elements resulting from step b).

24. The method of claim 18, wherein the one or more common playing elements consist of some, but not all, of the playing elements resulting from step b).

25. The method of claim 18, wherein at least one of the playing elements is displayed on one of an electronic display and an electromechanical display and at least one of the playing elements is displayed on a physical game piece.

26. The method of claim 25, wherein each playing element that is either held or redrawn in step b) is a physical game element.

27. The method of claim 26, wherein the playing elements displayed on the electronic or electromechanical display can not be held or redrawn in step b).

28. The method of claim 18, wherein the method is implemented using a computerised gaming system comprising a game controller and a user interface, wherein the game controller performs the selection in steps a), c), d) and e) and the decision to either hold or redraw one or more playing elements in step b) is performed by the player by operating the user interface.

29. The method of claim 18, when implemented using solely physical game pieces.

30. The method of claim 29, wherein the physical game pieces are cards.

31. A gaming system for providing a hold and draw style game, the gaming system comprising one or more displays, a game controller and a memory containing definitions of a plurality of playing elements, wherein the game controller:
selects and causes the presentation on the one or more displays representations of a first selection of one or more said playing elements,
monitors a user interface for an identification from a player to either hold or redraw at least one of the presented playing elements and selects and presents replacement playing elements from the plurality of playing elements defined in memory for any playing elements identified by the player to be redrawn so as to define a second selection of playing elements,
selects a third selection of a plurality of playing elements from the plurality of playing elements defined in memory and displays on the one or more displays the second and third selection of playing elements,
identifies a plurality of outcomes, each outcome defined by a combination of playing elements within the playing elements from the second and third selection of playing elements, at least two said outcomes having one or more playing elements from the second selection of playing elements in common, and
causes the award of an award if one or more the plurality of outcomes represents a winning outcome.

32. The gaming system of claim 31, wherein the number of said plurality of outcomes that are identified is dependent on an amount wagered by the player.

33. The gaming system of claim 31, wherein the first selection of playing elements consists of m playing elements and each said outcome consists of n playing elements, where m is one of two, three or four, and n is one of three, four, five and six and where m is less than or equal to n.

34. The gaming system of claim 33, wherein m is less than n and the third selection of playing elements is only displayed after the decision to hold or redraw has been made to define the second selection of playing elements.

35. The gaming system of claim 31, wherein the third selection of playing elements is displayed on at least one spinning reel.

36. The gaming system of claim 35, wherein the third selection of playing elements is displayed across two spinning reels.

37. The gaming system of claim 31, wherein the first, second and optionally also the third selections of playing elements are made from the same set of playing elements.

38. The gaming system of claim 37, wherein the selections are made without replacement.

39. The gaming system of claim 31, wherein all of the outcomes comprise the one or more common playing elements and at least one other playing element.

40. The gaming system of claim 31, wherein the outcomes comprise a plurality of groups of outcomes, wherein each group of outcomes has one or more common playing elements.

41. The gaming system of claim 31, wherein the first selection of one or more playing elements is displayed in one or more first rows and the third selection of playing elements is displayed in one or more columns, each said column having at least two second rows.

42. The gaming system of claim 41, wherein there is one said first row.

43. A method of forming a plurality of outcomes of playing items, the method comprising randomly selecting one or more playing items from at least one set of playing items, either holding or redrawing one or more of the playing items dependent on a player input, and then forming and presenting simultaneously a plurality of outcomes, each outcome having one or more of the playing items resulting from the step of holding or redrawing in common, the step of presenting comprising displaying only a single representation of the common playing items.

44. The method of claim 43, wherein at least some of the playing items are randomly selected by an electronic processing system and presented on a display controlled by the electronic processing system.

45. The method of claim 44, wherein the playing items in common to each outcome are each physical playing items.

46. The method of claim 44, wherein all of the playing items are randomly selected by an electronic processing system and presented on a display controlled by the electronic processing system.

47. A gaming system for providing a hold and draw style game, the gaming system comprising one or more displays, a user interface, a game controller and a memory containing definitions of a plurality of playing elements, wherein the game controller randomly selects one or more of the playing elements, either holds or redraws one or more of the playing elements dependent on a player decision entered using the user interface, forms a plurality of outcomes, each outcome having one or more of the playing items resulting from the step of holding or redrawing in common, and simultaneously displays each outcome on the display so that the one or more common playing items are only displayed once.

48. A gaming system comprising a display, an operator interface, and a controller in communication with the display and operator interface and operable to both control at least an aspect of game play of a game and cause representations of the game play to be displayed on the display, the controller selecting a plurality of playing elements from a set of playing elements and
displaying the playing elements on the display, receiving at the operator interface an indication of a partial or full outcome, and then defining a plurality of full outcomes using both the selected playing elements and the indication of the partial or full outcome, and evaluating whether one or more of said plurality of full outcomes is a winning outcome.

49. The gaming system of claim 48, wherein the controller receives an indication of two or more partial or full outcomes, each said partial or full outcome being associated with a separate player and is operable to evaluate distinctly for each player whether one of said plurality of full outcomes is a winning outcome.

50. The gaming system of claim 48, wherein the plurality of playing elements are common to each player.

51. The gaming system of claim 48, further comprising physical game pieces in the form of one of cards, dice, coins, dominos and numbered balls, wherein the indication of partial or full outcomes is dependent on a roll or deal of the physical game pieces.

52. The gaming system of claim 48, wherein the playing elements are symbols on spinning reels.

53. A method of gaming comprising:
a) allocating to at least one player one or more physical game pieces to form at least one first partial or complete outcome;
b) using a computational game controller and one or more displays to select and display a plurality of playing elements;
c) for each said player forming a plurality of distinct complete outcomes using the physical game pieces and the plurality of playing elements; and
d) determining whether the plurality of complete outcomes define one or more winning outcomes and if so awarding an award.

54. The method of claim 53, wherein for each said player step a) comprises allocating a first allocation of one or more physical game pieces, and either holding or redrawing one or more of the physical game pieces according to one or more decisions made by the player.

55. The method of claim 53, wherein the plurality of complete outcomes are each defined in part by the physical game pieces and defined in another part by one or more said playing element.

56. The method of claim 53, wherein there are at least two players.

57. A method of gaming comprising forming an outcome of at least two playing elements and awarding an award if the playing elements represent a winning combination, wherein at least one of the playing elements comprises a physical game piece and at least one of the playing elements comprises a playing element that has been randomly selected using a computational system and displayed on one of an electronic and electromechanical display.

58. The method of claim 57, wherein the physical game piece and the playing elements displayed on the display both define the same symbols.

59. The method of claim 57, wherein the method comprises forming a plurality of said outcomes for each player, each outcome having at least one playing element in common.

60. The method of claim 59, wherein the at least one playing element in common is the at least one playing element defined by a physical game piece.

61. The method of claim 57, wherein there is a plurality of players and the outcomes for each player have a plurality of playing elements in common with the outcomes of each other player.

62. A linked gaming system in which a plurality of gaming consoles each display one or more first playing elements representing at least part of an outcome in a game on a first display and the gaming system displays on a second display second playing elements representing part of a plurality of outcomes, wherein a plurality of outcomes for a game on the linked gaming system are defined by combining both the first and the second playing elements.

63. The linked gaming system of claim 62, wherein for each player at one of said gaming consoles, the first symbols are common to every one of said plurality of outcomes.

64. The linked gaming system of claim 62, further comprising a third display remote from the gaming consoles, the third display also showing representations of the second symbols.

65. A gaming system comprising a plurality of linked consoles each having a display and a game controller, wherein the game controller controls play of a game having a common aspect across the plurality of linked consoles and during play of the game causes the plurality of gaming consoles to each display on their respective display one or more first playing elements representing at least part of a plurality of outcomes in a game, the first playing elements being common across the gaming consoles, and display second playing elements representing at least another part of the plurality of outcomes, the second playing elements being randomly selected for each gaming console, wherein outcomes for a game on the linked gaming system are defined by both the first and second playing elements.

66. The gaming system of claim 65, wherein for each player at one of said gaming consoles, the second playing elements are common to every one of said plurality of outcomes.

67. The gaming system of claim 65, wherein the first playing elements are displayed on one or more spinning reels and the game controller selects the first playing elements by selecting the stopping position of the one or more spinning reels.

68. A method of providing a game comprising randomly selecting a first set of playing elements from a set of playing elements, providing the option to replace one or more of the playing elements in the first set with one or more other playing elements to thereby form a second set of playing elements, selecting a plurality of further playing elements and forming a plurality of outcomes, each outcome having the second set of playing elements in common and including a different one or combination of said further playing elements.

69. The method of claim 68, wherein the plurality of further playing elements are separated into groups and the number of outcomes is the product of the number of playing elements in each group.

70. The method of claim 68, further comprising randomly selecting at least one more set of playing elements from the set or another set of playing elements, providing the option to replace one or more of those playing elements to thereby form at least one further set of playing elements, and in relation to each further set of playing elements forming a further set of a plurality of outcomes in which each outcome has the playing elements from one of the further sets of playing elements in common and includes a different one or combination of said further playing elements.

71. The method of claim 70, wherein the plurality of further playing elements are separated into groups and the number of outcomes is the product of the number of playing elements in each group multiplied by the number of said further sets of playing elements.

72. A method of forming a plurality of outcomes of playing items, the method comprising randomly selecting and presenting one or more groups of reselectable playing elements, either holding or reselecting the reselectable playing elements dependent on a player input, and forming a plurality of outcomes from the reselectable playing elements and a plurality of further playing elements that form at least part of at least one set of playing elements, each set comprising either no reselectable playing elements or one of the reselectable playing elements from each group, wherein each outcome comprises only one playing element from each of the sets of playing elements and the number of outcomes is equal to the product of the number of playing elements in each set of playing elements multiplied by the number of groups of reselectable playing items and wherein every outcome comprises at least one common reselectable symbol.

73. The method of claim 72 when implemented by a game controller in communication with one or more displays and a player input device, wherein the game controller randomly selects the playing items and causes them to be presented on the one or more displays and wherein the reselectable playing items are either held or redrawn dependent on operation of the player input.

74. The method of claim 72, wherein there are a plurality of groups of reselectable playing items.

75. The method of claim 72, wherein there are a plurality of sets of playing items.

76. The method of claim 72, further comprising repeating the process for a plurality of players, wherein the reselectable playing items may differ between the players and the further playing items are controlled to be the same for all of the players.

77. A gaming machine comprising a game controller in communication with one or more displays and a player input device, the game controller randomly selecting one or more groups of playing elements, either holding or reselecting those playing elements dependent on input from the player input device, and presents on the one or more displays a plurality of outcomes from the reselectable playing elements and a plurality of further playing elements that form at least part of at least one set of playing elements, each set comprising either no reselectable playing elements or one of the reselectable playing elements from each group, wherein each outcome comprises only one playing element from each of the sets of playing elements and the number of outcomes is equal to the product of the number of playing elements in each set of playing elements multiplied by the number of groups of reselectable playing items and wherein every outcome comprises at least one common reselectable symbol.

78. The gaming machine of claim 77, wherein there are a plurality of said groups of playing elements.

79. The gaming machine of claim 77, wherein there are a plurality of said sets of playing elements.

80. A method of gaming comprising forming a plurality of outcomes, evaluating the plurality of outcomes for the occurrence of one or more winning outcomes and dependent on the evaluation awarding an award, the step of forming a plurality of outcomes comprising randomly selecting a plurality of playing elements and either holding or redrawing at least one said playing element, wherein the outcomes are defined to avoid the possibility of conflicting possible winning strategies when making the decision to either hold or redraw at least one said playing element and wherein the plurality of playing elements are presented without the duplicate display of playing elements.

81. The method of claim 80, wherein each said outcome belongs to one of one or more groups, each group having one or more playing elements in common that have directly resulted from said decision to either hold or redraw.

82. The method of claim 81, wherein there is only one said group.

83. The method of claim 81, wherein the step of presenting comprises showing multiple pay lines, each pay line in a said group traversing the one or more playing elements in common.

84. The method of claim 80, wherein the plurality of outcomes comprise at least 25 outcomes.

85. The method of claim 80, wherein at least one playing element from each of the plurality of outcomes is selected by a gaming controller based on random criteria and presented on a display in communication with the gaming controller.

86. The method of claim 85, wherein the game is a spinning reel game and the display comprises a plurality of spinning reels and wherein the plurality of outcomes are defined by paylines that traverse the spinning reels, and the step of either holding or redrawing involves holding or respinning one or more of the reels.

87. A gaming system comprising a display and a user interface in communication with a game controller for providing a hold and draw style game in which a plurality of playing elements are selected and if a particular combination of playing elements occurs the gaming system awards an award, the gaming system further comprising memory containing definitions of a plurality of playing elements, wherein the game controller:
selects and presents a plurality of playing elements in a selection process during which one or more playing elements are selected and presented to a player; and
either holds or redraws at least one of the playing elements dependent on operation of the user interface by the player;
wherein the outcomes are defined to avoid the possibility of conflicting possible winning strategies when completing the step of either holding or redrawing at least one of the playing elements, and are presented without the duplicate display of playing elements, either simultaneously or consecutively.

88. A method of gaming comprising forming a plurality of outcomes and awarding an award if the outcomes represent one or more winning outcomes, the step of forming a plurality of outcomes comprising a process involving a random selection of a plurality of playing elements and during which:
a decision is made to either hold or redraw at least one said playing element, and
defining each of the plurality of outcomes as the playing elements in a pattern within the plurality of playing elements as displayed, wherein at least two patterns have at least one playing element in common,
wherein the outcomes are further defined to avoid the possibility of conflicting possible winning strategies when making the decision to either hold or redraw at least one said playing element.

89. A gaming system comprising a display and a user interface in communication with a game controller for providing a hold and draw style game in which a plurality of playing elements are selected and if a particular combination of playing elements occurs the gaming system awards an award, the gaming system further comprising memory containing definitions of a plurality of playing elements, wherein the game controller:
selects and presents a plurality of playing elements in a selection process during which one or more playing elements are selected and presented to a player;
either holds or redraws at least one of the playing elements dependent on operation of the user interface by the player; and
defines each of the plurality of outcomes as the playing elements in a pattern within the plurality of playing elements as displayed, wherein at least two patterns have at least one playing element in common,
wherein the outcomes are further defined to avoid the possibility of conflicting possible winning strategies when completing the step of either holding or redrawing at least one of the playing elements.
